(19) United States
(12) Patent Application Publication
(10) Pub. No.: US 2017/0015536 A1
(43) Pub. Date: Jan. 19, 2017

(54) BRAKE DEVICE FOR ELEVATOR HOIST

(71) Applicant: MITSUBISHI ELECTRIC CORPORATION, Chiyoda-ku, Tokyo (JP)

(72) Inventors: Maya Irie, Chiyoda-ku (JP); Hitoshi Ota, Chiyoda-ku (JP); Tomokazu Hoshinoo, Chiyoda-ku (JP)

(73) Assignee: MITSUBISHI ELECTRIC CORPORATION, Chiyoda-ku, Tokyo (JP)

(21) Appl. No.: 15/301,675

(22) PCT Filed: May 13, 2014
(86) PCT No.: PCT/JP2014/062687

§ 371 Date: Oct. 3, 2016

(51) Int. Cl. B66D 5/28; B66D 5/12; B66B 5/00; F16D 65/28; B66B 11/04

(52) U.S. Cl. CPC B66D 5/28; F16D 65/28; B66B 11/04; B66B 5/00; B66D 5/12; F16D 2121/04

(57) ABSTRACT

A brake device for an elevator hoisting machine includes: a rod movable in an axial direction; a plurality of pistons provided to the rod so as to be arranged side by side in the axial direction; a cylinder configured to accommodate each of the pistons therein and including a pressure control chamber formed between the cylinder and each of the pistons; a lining provided to the rod so as to be capable of coming into contact with a contacted body; and a spring device configured to press the pistons in a direction in which the lining is pressed against the contacted body. Gaps are respectively formed between at least one of the plurality of pistons and the rod and between pistons adjacent to each other. Each of the pistons is configured to be driven by a change in air pressure in the pressure control chamber.

### TECHNICAL FIELD

The present invention relates to a brake device for an elevator hoisting machine.

### BACKGROUND ART

Hitherto, there is known a brake device including a piston formed in a multi-stage fashion so that a radial dimension is increased from one end side to another end side in an axial direction, and a cylinder configured to accommodate the piston therein and including pressure control chambers respectively formed between the stages of the piston. The brake device is configured to control a flow of air into each of the pressure control chambers in accordance with a required pressing force (see, for example, Patent Literature 1).

### CITATION LIST

### Patent Literature

[PTL 1] JP 62-295764 A

### SUMMARY OF INVENTION

### Technical Problem

However, the pressing force is generated by a pressure of the air flowing into each of the pressure control chambers. Thus, there is a problem in that the pressing force is small. Further, when the piston is formed in the multi-stage fashion, twisting is liable to occur between the piston and the cylinder. Therefore, in order to prevent the occurrence of twisting between the piston and the cylinder, design and manufacture are required to be performed with increased processing accuracy. As a result, there are problems in that processing cost is increased and high assembly accuracy is required to assemble the piston into the cylinder.

The present invention provides a brake device for an elevator hoisting machine, which is capable of increasing a pressing force and preventing occurrence of twisting between pistons and a cylinder without increasing processing accuracy.

### Solution to Problem

According to one embodiment of the present invention, there is provided a brake device for an elevator hoisting machine, including: a rod movable in an axial direction of the rod; a plurality of pistons provided to the rod so as to be arranged side by side in the axial direction; a cylinder configured to accommodate each of the plurality of pistons therein, the cylinder including a pressure control chamber formed between the cylinder and the each of the plurality of pistons; a lining provided to the rod so as to be capable of coming into contact with a contacted body; and a spring device configured to press the plurality of pistons in a direction in which the lining is pressed against the contacted body, the brake device having gaps respectively formed between at least one of the plurality of pistons and the rod and between pistons adjacent to each other among the plurality of pistons, the each of the plurality of pistons being configured to be driven by a change in air pressure in the pressure control chamber.

### Advantageous Effects of Invention

According to the brake device for an elevator hoisting machine of the present invention, the lining is pressed against the contacted body by using an elastic force of the spring device and a force of the air pressure generated in the same direction as that of the elastic force of the spring device. Therefore, the pressing force can be increased. Further, the gaps are respectively formed between the rod and the pistons and between the pistons adjacent to each other. Therefore, the occurrence of twisting between the pistons and the cylinder can be prevented without increasing processing accuracy such as a concentricity. Thus, a frequency of maintenance can be reduced. Further, ease of assembly of the pistons and the rod is improved. Thus, efficiency of assembly at the time of manufacturing and at the time of maintenance can be improved.

### BRIEF DESCRIPTION OF DRAWINGS

FIG. 1 is a sectional view for illustrating a brake device for an elevator hoisting machine according to a first embodiment of the present invention.

FIG. 2 is a configuration diagram for illustrating peripheral devices configured to drive the brake device for an elevator hoisting machine, which is illustrated in FIG. 1.

FIG. 3 is a graph set for showing a relationship between a flow rate of air and the amount of air passing through second air passage holes and movement of a lining.

FIG. 4 is a graph set for showing a relationship between a flow rate of air and the amount of air passing through first air passage holes and the movement of the lining.

FIG. 5 is a sectional view for illustrating a brake device for an elevator hoisting machine according to a second embodiment of the present invention.

FIG. 6 is a sectional view for illustrating a brake device for an elevator hoisting machine according to a third embodiment of the present invention.

FIG. 7 is a sectional view for illustrating a brake device for an elevator hoisting machine according to a fourth embodiment of the present invention.

FIG. 8 is a sectional view for illustrating a brake device for an elevator hoisting machine according to a fifth embodiment of the present invention.

FIG. 9 is a sectional view for illustrating a brake device for an elevator hoisting machine according to a sixth embodiment of the present invention.

FIG. 10 is a sectional view for illustrating a modification of the brake device for an elevator hoisting machine, which is illustrated in FIG. 9.

FIG. 11 is a sectional view for illustrating a brake device for an elevator hoisting machine according to a seventh embodiment of the present invention.

FIG. 12 is a sectional view for illustrating a brake device for an elevator hoisting machine according to an eighth embodiment of the present invention.

FIG. 13 is a sectional view for illustrating a brake device for an elevator hoisting machine according to a ninth embodiment of the present invention.

FIG. 14 is a sectional view for illustrating a brake device for an elevator hoisting machine according to a tenth embodiment of the present invention.

FIG. 15 is a sectional view for illustrating a brake device for an elevator hoisting machine according to an eleventh embodiment of the present invention.

FIG. 16 is a sectional view for illustrating a modification of the brake device for an elevator hoisting machine, which is illustrated in FIG. 15.

FIG. 17 is a sectional view for illustrating a brake device for an elevator hoisting machine according to a twelfth embodiment of the present invention.

FIG. 18 is a sectional view for illustrating a brake device for an elevator hoisting machine according to a thirteenth embodiment of the present invention.

FIG. 19 is a sectional view for illustrating a brake device for an elevator hoisting machine according to a fourteenth embodiment of the present invention.

FIG. 20 is an enlarged view for illustrating a main part of the brake device for an elevator hoisting machine, which is illustrated in FIG. 19.

FIG. 21 is an enlarged view for illustrating the main part of the brake device for an elevator hoisting machine, which is illustrated in FIG. 19.

### DESCRIPTION OF EMBODIMENTS

Now, embodiments of the present invention are described with reference to the drawings. In the drawings, the same or corresponding members and parts are denoted by the same reference symbols for description.

### First Embodiment

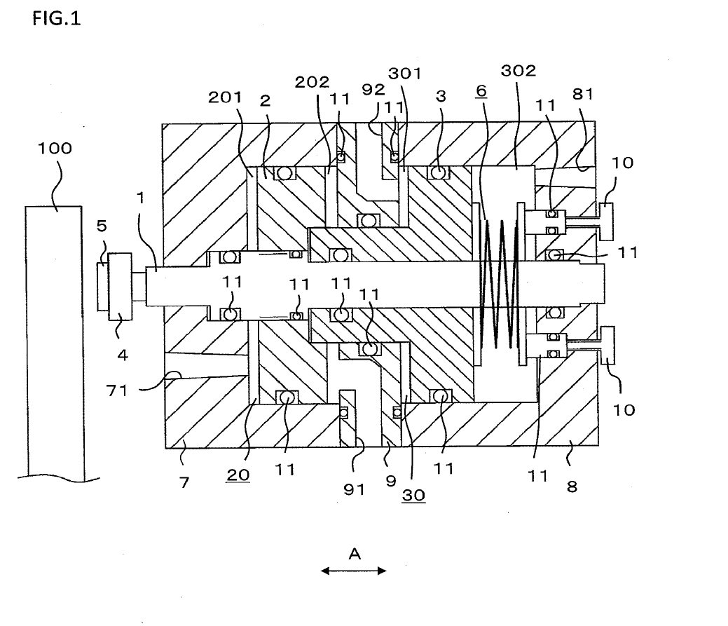

FIG. 1 is a sectional view for illustrating a brake device for an elevator hoisting machine according to a first embodiment of the present invention. In FIG. 1, the brake device for an elevator hoisting machine includes a rod 1 movable in an axial direction, a first pressure-receiving piston (piston) 2 provided to the rod 1, a second pressure-receiving piston (piston) 3 provided to the rod 1, a shoe 4 provided to a distal end portion of the rod 1, a lining 5 provided to the shoe 4 so as to be capable of coming into contact with a disc (contacted body) 100, and a spring device 6 configured to press the second pressure-receiving piston 3 in a direction in which the lining 5 is pressed against the disc 100.

The brake device for an elevator hoisting machine further includes a first cylinder tube 7 configured to guide the first pressure-receiving piston 2, a second cylinder tube 8 configured to guide the second pressure-receiving piston 3, and an intermediate cylinder tube 9 coupling the first cylinder tube 7 and the second cylinder tube 8 to each other. The first cylinder tube 7, the second cylinder tube 8, and the intermediate cylinder tube 9 form a cylinder.

The first pressure-receiving piston 2 and the second pressure-receiving piston 3 are arranged so as to be separated away from each other in the axial direction. Specifically, a gap is formed between the first pressure-receiving piston 2 and the second pressure-receiving piston 3. In this example, the “axial direction” is an axial direction for the rod 1 and is a direction indicated by the arrow A in FIG. 1. Further, each of the first pressure-receiving piston 2 and the second pressure-receiving piston 3 is formed as a body independent of the rod 1. Specifically, a gap is formed between the first pressure-receiving piston 2 and the rod 1, while a gap is formed between the second pressure-receiving piston 3 and the rod 1. The first pressure-receiving piston 2 and the second pressure-receiving piston 3 are completely separated away from each other. The first pressure-receiving piston 2 and the second pressure-receiving piston 3 are configured to transmit a pressure therebetween when the first pressure-receiving piston 2 and the second pressure-receiving piston 3 come into surface contact with each other. When a position of the second pressure-receiving piston 3 is constantly kept the same in a rotating direction with respect to the first pressure-receiving piston 2, a rotation stopper for the second pressure-receiving piston 3 with respect to the first pressure-receiving piston 2 is provided.

A first pressure control chamber (pressure control chamber) 20 is formed by the first pressure-receiving piston 2, the first cylinder tube 7, and the intermediate cylinder tube 9. A second pressure control chamber (pressure control chamber) 30 is formed by the second pressure-receiving piston 3, the second cylinder tube 8, and the intermediate cylinder tube 9. The first pressure control chamber 20 includes a first pressure control section 201 corresponding to a region closer to the lining 5 than the first pressure-receiving piston 2 and a second pressure control section 202 corresponding to a region farther from the lining 5 than the first pressure-receiving piston 2. The second pressure control chamber 30 includes a first pressure control section 301 corresponding to a region closer to the lining 5 than the second pressure-receiving piston 3 and a second pressure control section 302 corresponding to a region farther from the lining 5 than the second pressure-receiving piston 3.

A first air passage hole 71 through which air passes between the first pressure control section 201 and outside is formed in a portion of the first cylinder tube 7, which is opposed to the first pressure-receiving piston 2 in the axial direction.

A second air passage hole 91 through which the air passes between the second pressure control section 202 and the outside is formed in the intermediate cylinder tube 9. A portion of the second air passage hole 91, which is located on the second pressure control section 202 side, is formed so as to extend in the axial direction.

A second air passage hole 81 through which the air passes between the second pressure control section 302 and the outside is formed in a portion of the second cylinder tube 8, which is opposed to the second pressure-receiving piston 3 in the axial direction.

A first air passage hole 92 through which the air passes between the first pressure control section 301 and the outside is formed in the intermediate cylinder tube 9. A portion of the first air passage hole 92, which is located on the first pressure control section 301 side, is formed so as to extend in the axial direction.

The spring device 6 is arranged so as to be adjacent to the second pressure-receiving piston 3 in the axial direction. The spring device 6 is formed of a single coil spring. The spring device 6 is mounted over the rod 1 by inserting the rod 1 into a central portion of the coil spring. The spring device 6 presses the second pressure-receiving piston 3 toward the lining 5, thereby pressing the rod 1 in a direction in which the lining 5 is pressed against the disc 100.

The brake device for an elevator hoisting machine further includes spring-length adjusting screws 10 provided to the second cylinder tube 8. The spring-length adjusting screws 10 move forward and backward in the axial direction with respect to the second cylinder tube 8, thereby adjusting a spring length of the spring device 6.

The brake device for an elevator hoisting machine further includes sealing members 11 respectively provided between the rod 1 and the first cylinder tube 7, between the rod 1 and the intermediate cylinder tube 9, between the rod 1 and the second cylinder tube 8, between the first pressure-receiving piston 2 and the first cylinder tube 7, between the second pressure-receiving piston 3 and the second cylinder tube 8, between the first cylinder tube 7 and the intermediate cylinder tube 9, between the second cylinder tube 8 and the intermediate cylinder tube 9, between the first pressure-receiving piston 2 and the rod 1, between the second pressure-receiving piston 3 and the rod 1, between the second pressure-receiving piston 3 and the intermediate cylinder tube 9, and between each of the spring-length adjusting screws 10 and the second cylinder tube 8.

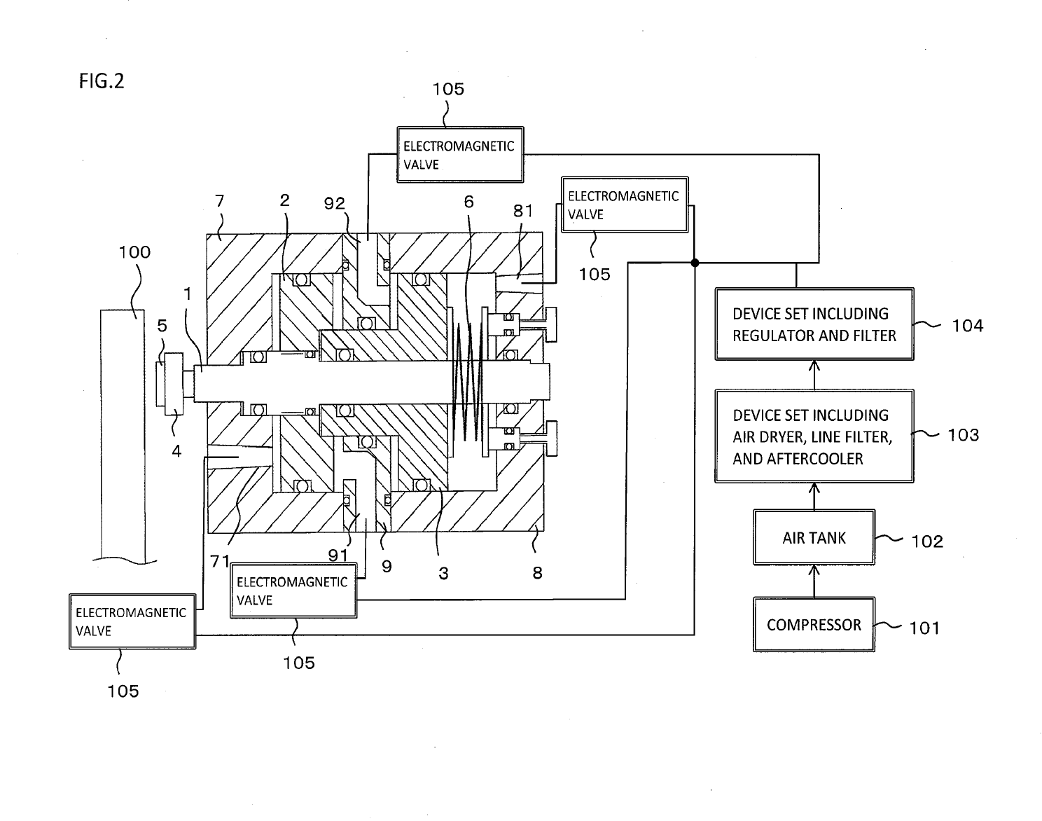

FIG. 2 is a configuration diagram for illustrating peripheral devices configured to drive the brake device for an elevator hoisting machine, which is illustrated in FIG. 1. Air compressed by a compressor 101 is fed to the first air passage hole 71, the second air passage hole 81, the second air passage hole 91, and the first air passage hole 92 through an air tank 102, a device set 103 including an air dryer, a line filter, and an after cooler, a device set 104 including a regulator and a filter, and electromagnetic valves 105.

In this example, the air fed to the first air passage hole 71, the second air passage hole 81, the second air passage hole 91, and the first air passage hole 92 is controlled by the different electromagnetic valves 105. However, the air fed to the first air passage hole 71 and the first air passage hole 92 may be controlled by one or more of the electromagnetic valves 105, whereas the air fed to the second air passage hole 81 and the second air passage hole 91 may be controlled by the single electromagnetic valve 105. Further, branch points from the device set 104 including the regulator and the filter to the respective electromagnetic valves 105 are not required to be provided at the same position. Further, a plurality of sets of the peripheral devices except for the electromagnetic valves 105 may be provided to the single brake device for an elevator hoisting machine. Alternatively, the plurality of brake devices for an elevator hoisting machine may be driven by a single set of the peripheral devices except for the electromagnetic valves 105.

Next, an operation of the brake device for an elevator hoisting machine is described. In a state in which the compressed air is not fed to the first pressure control chamber 20 and the second pressure control chamber 30, the lining 5 is pressed against the disc 100 by the elastic force of the spring device 6. In this manner, rotation of the disc 100 is braked.

When the disc 100 is released, air at a pressure equal to or higher than 0.2 MPa is supplied through the first air passage hole 71 to the first pressure control section 201, whereas air at a pressure equal to or higher than 0.2 MPa is supplied through the first air passage hole 92 to the first pressure control section 301. In this manner, a force of the air pressure, which is larger than the elastic force of the spring device 6, is applied to the first pressure-receiving piston 2 and the second pressure-receiving piston 3, thereby moving the rod 1 in a direction in which the spring device 6 is contracted. As a result, the lining 5 is separated away from the disc 100 to release the disc 100.

When the disc 100 is released, final ends of the first pressure-receiving piston 2 and the second pressure-receiving piston 3 may be located at any of a point at which the elastic force of the spring device 6 and the force of the air pressure are in equilibrium, a point at which the first pressure-receiving piston 2 and the intermediate cylinder tube 9 come into contact with each other, and a point at which the second pressure-receiving piston 3 and the second cylinder tube 8 come into contact with each other.

The first pressure-receiving piston 2 and the rod 1 are connected through thread fastening. Therefore, through rotation of the rod 1 in a circumferential direction, the rod 1 is moved in the axial direction with respect to the first cylinder tube 7, the second cylinder tube 8, and the intermediate cylinder tube 9. As a result, the lining 5 is moved in the axial direction, thereby adjusting a distance between the lining 5 and the disc 100.

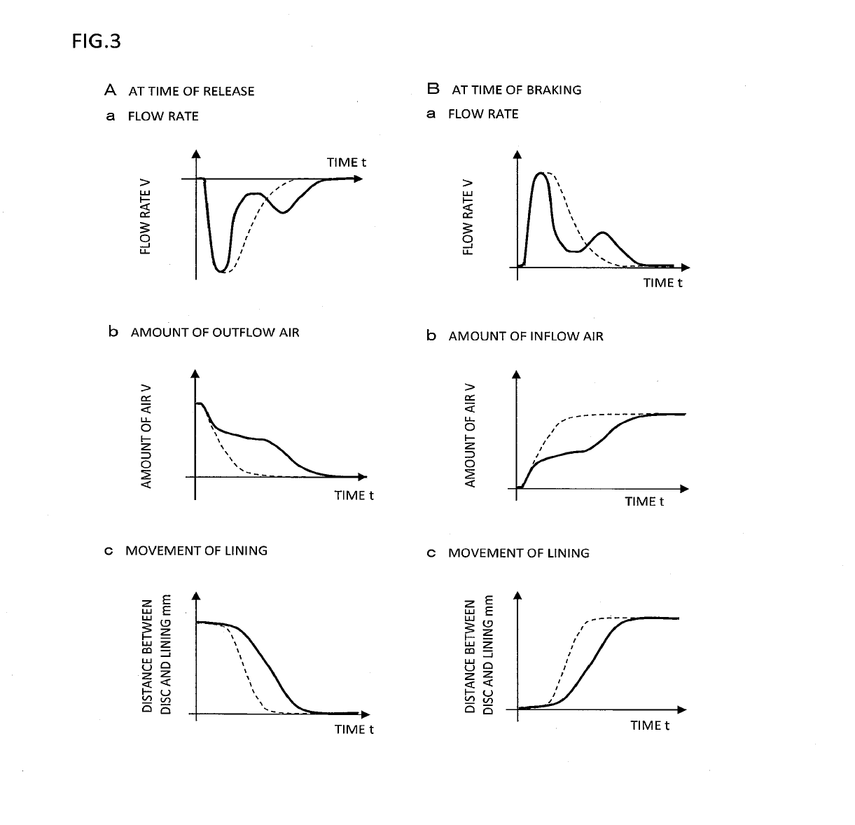

FIG. 3 is a graph set for showing a relationship between a flow rate of air and the amount of air passing through the second air passage holes 91 and 81 and the movement of the lining 5. In FIG. 3, the dotted line indicates the flow rate of air, the amount of air, and the movement of the lining 5 when the flow rate of air is not controlled, whereas the solid line indicates the flow rate of air, the amount of air, and the movement of the lining 5 when the flow rate of air is controlled. When the flow rate of air to flow into and out of the second air passage hole 91 and the second air passage hole 81 is controlled by the electromagnetic valves 105 so as to press the lining 5 against the disc 100 and separate the lining 5 away from the disc 100 by the elastic force of the spring device 6, the force generated by the air pressure is supplied to the first pressure-receiving piston 2 and the second pressure-receiving piston 3 so that the force generated by the air pressure is transmitted to the lining 5 through the rod 1. Through control of the flow of air into and out of the second air passage hole 91 and the second air passage hole 81, a moving speed of the rod 1 is controlled. Specifically, when the lining 5 is pressed against the disc 100 and the lining 5 is separated away from the disc 100, the moving speed of the rod 1 is controlled. Further, through control of the moving speed of the rod 1, noise generated when the first pressure-receiving piston 2 and the second pressure-receiving piston 3, and the cylinder come into contact with each other can be reduced.

When the disc 100 is braked, the pressure is maintained after the air is supplied from the second air passage hole 91 and the second air passage hole 81. In this manner, the lining 5 is pressed against the disc 100 by the force generated by the air pressure in addition to the pressing force generated by the spring device 6. As a result, as compared to a case where the lining 5 is pressed against the disc 100 by using only the pressing force generated by the spring device 6, the lining 5 can be pressed against the disc 100 with a larger force.

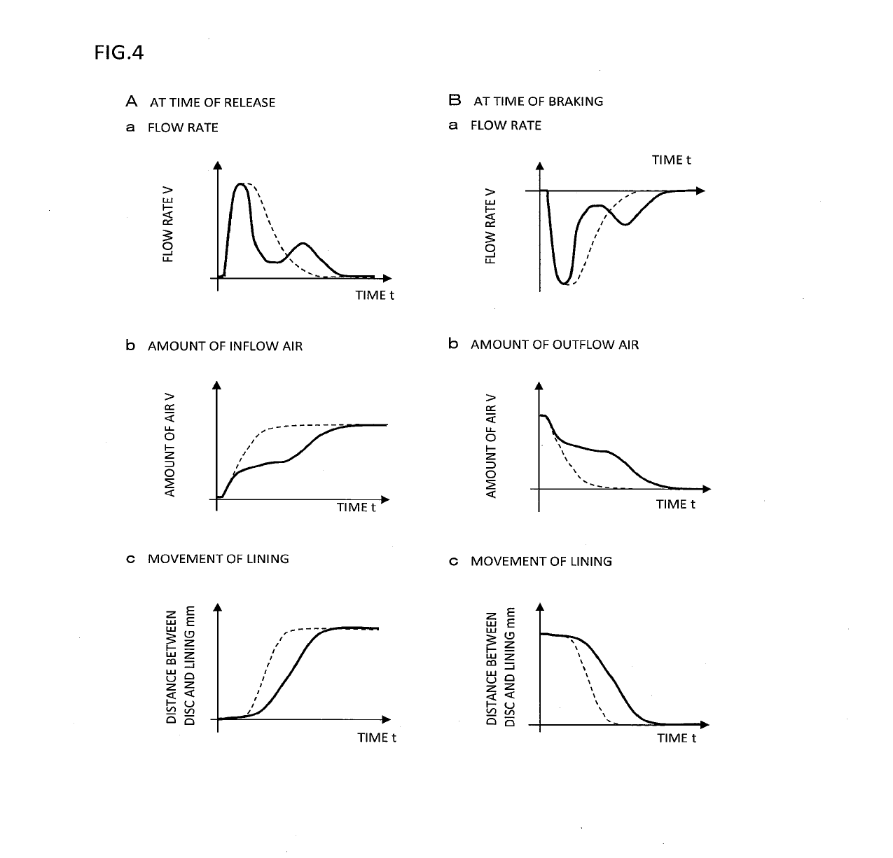

FIG. 4 is a graph set for showing a relationship between a flow rate of air and the amount of air passing through the first air passage holes 71 and 92 and the movement of the lining 5. In FIG. 4, the dotted line indicates the flow rate of air, the amount of air, and the movement of the lining 5 when the flow rate of air is not controlled, whereas the solid line indicates the flow rate of air, the amount of air, and the movement of the lining 5 when the flow rate of air is controlled. When the flow rate of air to flow into and out of the first air passage hole 71 and the first air passage hole 92 is controlled by the electromagnetic valves 105 so as to press the lining 5 against the disc 100 and separate the lining 5 away from the disc 100 by the elastic force of the spring device 6, the force generated by the air pressure is supplied to the first pressure-receiving piston 2 and the second pressure-receiving piston 3 so that the force generated by the air pressure is transmitted to the lining 5 through the rod 1. Through control of the flow of the air into and out of the first air passage hole 71 and the first air passage hole 92, the moving speed of the rod 1 is controlled. Specifically, when the lining 5 is pressed against the disc 100 and the lining 5 is separated away from the disc 100, the moving speed of the rod 1 is controlled. Further, through control of the moving speed of the rod 1, noise generated when the first pressure-receiving piston 2 and the second pressure-receiving piston 3, and the cylinder come into contact with each other can be reduced.

In order to reduce effects of compressibility of the air, a volume of the first pressure control section 201 is set smaller than that of the second pressure control section 202, and a volume of the first pressure control section 301 is set smaller than that of the second pressure control section 302.

As described above, according to the brake device for an elevator hoisting machine of the first embodiment of the present invention, the lining 5 is pressed against the disc 100 by using the elastic force of the spring device 6 and the force generated by the air pressure. Therefore, the pressing force can be increased. Further, the gaps are respectively formed between the first pressure-receiving piston 2 and the rod 1, between the second pressure-receiving piston 3 and the rod 1, and between the first pressure-receiving piston 2 and the second pressure-receiving piston 3. Therefore, occurrence of twisting between the first pressure-receiving piston 2 and the second pressure-receiving piston 3, and the cylinder can be prevented without increasing processing accuracy such as a concentricity. Therefore, a frequency of maintenance can be reduced. Further, ease of assembly of the first pressure-receiving piston 2, the second pressure-receiving piston 3, and the rod 1 is improved. Thus, assembly efficiency at the time of manufacturing and at the time of maintenance can be improved.

According to the brake device for an elevator hoisting machine of the first embodiment of the present invention, the first pressure-receiving piston 2 and the second pressure-receiving piston 3 come into surface contact with each other. Therefore, as compared to the case where the first pressure-receiving piston 2 and the second pressure-receiving piston 3 are thread-fastened, breakage of a thread-fastened portion can be reduced. In addition, manufacture and assembly of the brake device for an elevator hoisting machine can be facilitated.

In the first embodiment described above, the spring device 6 comes into contact with the second pressure-receiving piston 3. However, the spring device 6 may come into contact with the first pressure-receiving piston 2 instead.

### Second Embodiment

FIG. 5 is a sectional view for illustrating a brake device for an elevator hoisting machine according to a second embodiment of the present invention. In the first embodiment, the first pressure-receiving piston 2 and the rod 1 are connected through the thread fastening. Through rotation of the rod 1 in the circumferential direction, the rod 1 is moved in the axial direction with respect to the first cylinder tube 7, the second cylinder tube 8, and the intermediate cylinder tube 9, thereby adjusting the distance between the lining 5 and the disc 100. In order to suppress leakage of the air through the gap in the thread-fastened portion, the sealing member 11 is provided between the first pressure-receiving piston 2 and the rod 1. The sealing member 11 is provided so as not to inhibit the movement of the rod 1 when the distance between the lining 5 and the disc 100 is adjusted.

On the other hand, in the brake device for an elevator hoisting machine according to the second embodiment, the first pressure-receiving piston 2 is formed integrally with the rod 1. The second pressure-receiving piston 3 and the rod 1 are connected through the thread fastening.

Further, in the brake device for an elevator hoisting machine, the adjustment of the distance between the lining 5 and the disc 100 is not required. A rotation stopper member 12 configured to fix the rotation of the second pressure-receiving piston 3 with respect to the rod 1 is further provided. Inhibition of the movement of the rod 1 at the time of adjustment of the distance between the lining 5 and the disc 100 is not required to be taken into consideration. Therefore, the second pressure-receiving piston 3 is thread-fastened to the rod 1. Further, after a clearance between the rod 1 and the second pressure-receiving piston 3 is sealed by using a sealing tape, the rotation of the rod 1 with respect to the second pressure-receiving piston 3 is restricted by using the rotation stopper member 12. In this manner, the second pressure-receiving piston 3 is fixed to the rod 1. The remaining configuration is the same as that of the first embodiment.

As described above, according to the brake device for an elevator hoisting machine of the second embodiment of the present invention, the sealing member 11 is not required to be provided between the second pressure-receiving piston 3 and the rod 1. Therefore, groove processing for the sealing member 11 is eliminated. In addition, the number of assembly components is reduced. As a result, the processing and assembly of the brake device for an elevator hoisting machine can be simplified.

### Third Embodiment

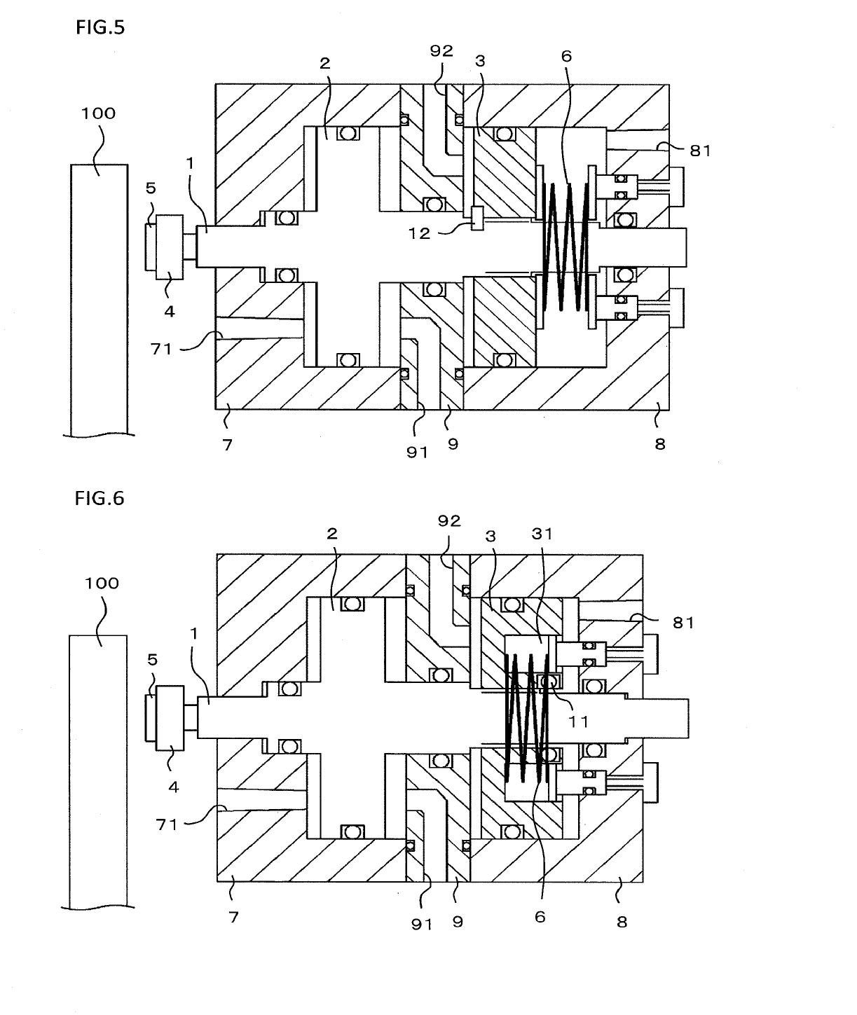

FIG. 6 is a sectional view for illustrating a brake device for an elevator hoisting machine according to a third embodiment of the present invention. In the second embodiment, the spring device 6 is arranged so as to be adjacent to the second pressure-receiving piston 3 in the axial direction.

On the other hand, in the brake device for an elevator hoisting machine according to the third embodiment, a groove 31 is formed in the second pressure-receiving piston 3. The spring device 6 is embedded in the groove 31. The rotation stopper member 12 is not provided between the second pressure-receiving piston 3 and the rod 1. The sealing member 11 is provided between the second pressure-receiving piston 3 and the rod 1. The remaining configuration is the same as that of the second embodiment.

As described above, according to the brake device for an elevator hoisting machine of the third embodiment of the present invention, the spring device 6 is embedded in the groove 31. Therefore, a dimension of the brake device for an elevator hoisting machine in the axial direction can be reduced. As a result, the brake device for an elevator hoisting machine can be downsized and reduced in weight.

### Fourth Embodiment

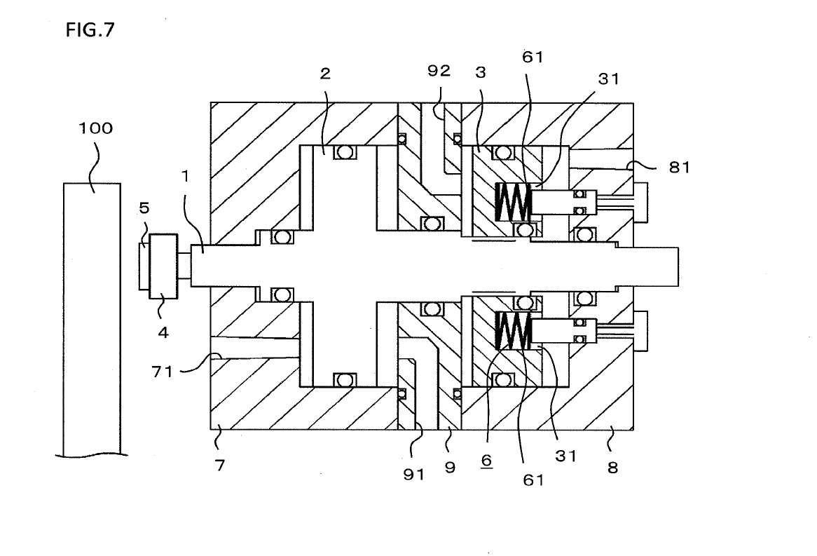

FIG. 7 is a sectional view for illustrating a brake device for an elevator hoisting machine according to a fourth embodiment of the present invention. In the third embodiment, the spring device is formed of a single spring provided in the second pressure-receiving piston 3. On the other hand, in the brake device for an elevator hoisting machine according to the fourth embodiment, the spring device 6 is formed of a plurality of springs 61. The plurality of springs 61 are arranged side by side in the circumferential direction of the rod 1. The number of the grooves 31, which corresponds to the number of the springs 61, are formed in the second pressure-receiving piston 3 so as to be arranged side by side in the circumferential direction. The springs 61 are respectively embedded in the grooves 31. The remaining configuration is the same as that of the third embodiment.

As described above, according to the brake device for an elevator hoisting machine of the fourth embodiment of the present invention, the spring device 6 includes the plurality of springs 61. Therefore, the elastic force of the spring device 6 can be increased. As a result, the force for pressing the lining 5 against the disc 100 through the second pressure-receiving piston 3, the rod 1, and the shoe 4 can be increased.

### Fifth Embodiment

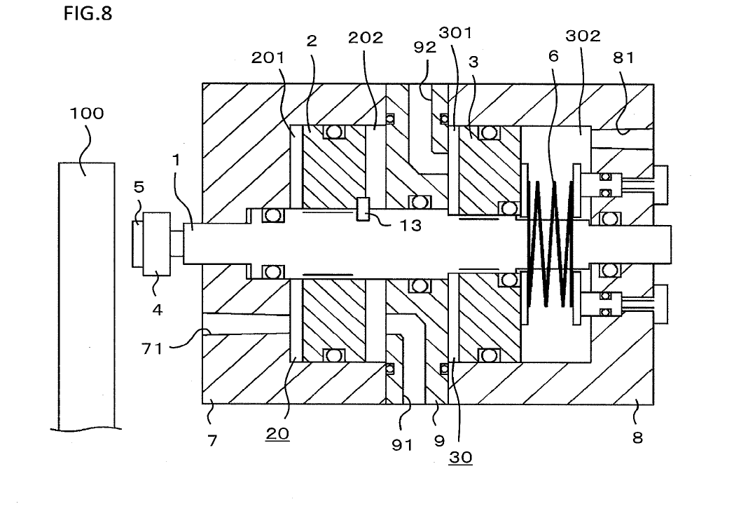

FIG. 8 is a sectional view for illustrating a brake device for an elevator hoisting machine according to a fifth embodiment of the present invention. The brake device for an elevator hoisting machine according to the fifth embodiment further includes a rotation stopper member 13 configured to fix the first pressure-receiving piston 2 to the rod 1. After the first pressure-receiving piston 2 is thread-fastened to the rod 1 and the clearance between the rod 1 and the first pressure-receiving piston 2 is sealed by using the sealing tape, the rotation of the rod 1 with respect to the first pressure-receiving piston 2 is restricted by using the rotation stopper member 13. As a result, the first pressure-receiving piston 2 is fixed to the rod 1. The second pressure-receiving piston 3 is connected to the rod 1 through the thread fastening. The remaining configuration is the same as that of the second embodiment.

As described above, according to the brake device for an elevator hoisting machine of the fifth embodiment of the present invention, the first pressure-receiving piston 2 and the rod 1 are separated from each other. Therefore, the manufacture and assembly of the brake device for an elevator hoisting machine can be facilitated.

### Sixth Embodiment

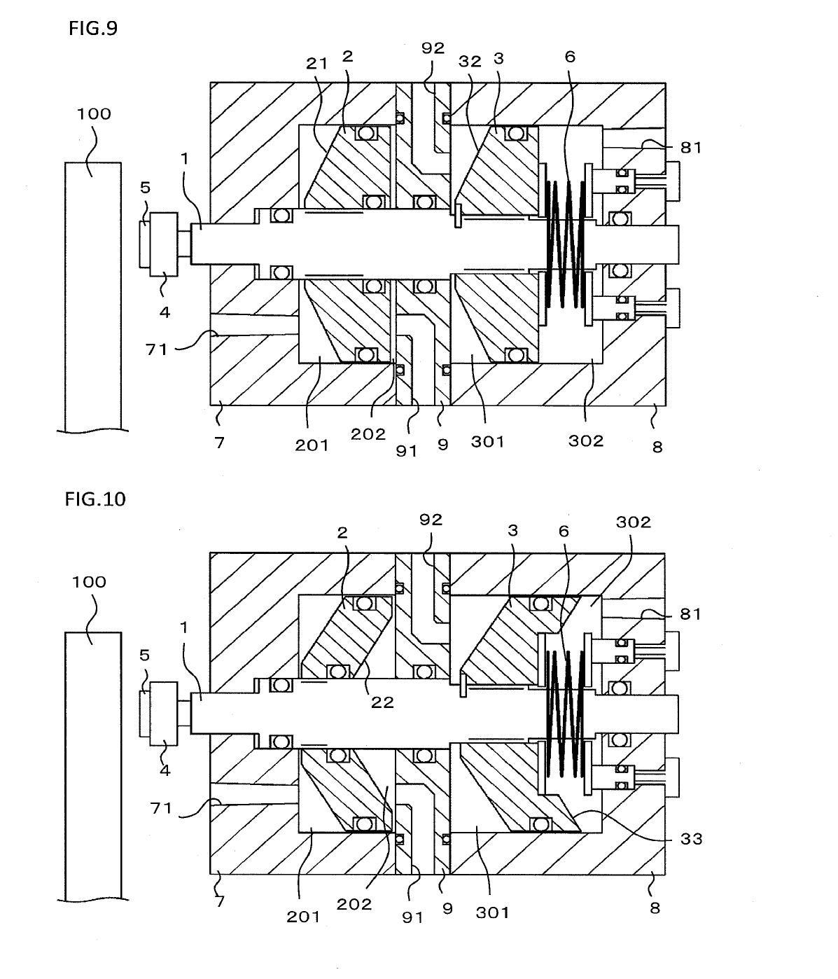

FIG. 9 is a sectional view for illustrating a brake device for an elevator hoisting machine according to a sixth embodiment of the present invention. In the first to fifth embodiments, a surface of the first pressure-receiving piston 2, which is located on the first pressure control section 201 side, and a surface of the second pressure-receiving piston 3, which is located on the first pressure control section 301 side, are arranged so as to be parallel to a plane perpendicular to the axial direction. On the other hand, in the brake device for an elevator hoisting machine according to the sixth embodiment, a first pressure-receiving surface 21 of the first pressure-receiving piston 2, which is a surface on the first pressure control section 201 side, and a first pressure-receiving surface 32 of the second pressure-receiving piston 3, which is a surface on the first pressure control section 301 side, are arranged so as to be inclined with respect to the plane perpendicular to the axial direction. Specifically, the first pressure-receiving surface 21 and the first pressure-receiving surface 32 are arranged so as to be separated away from the disc 100 as approaching from a radially inner side toward a radially outer side. The first pressure-receiving piston 2 is connected to the rod 1 through the thread fastening. The sealing member 11 is provided between the first pressure-receiving piston 2 and the rod 1. The remaining configuration is the same as that of the second embodiment.

As described above, according to the brake device for an elevator hoisting machine of the sixth embodiment of the present invention, the first pressure-receiving surface 21 and the first pressure receiving surface 32 are arranged so as to be inclined with respect to the plane perpendicular to the axial direction. Thus, the amount of air flowing into the first pressure control section 201 and the first pressure control section 301 can be increased. As a result, a speed of braking and releasing the disc 100 and the pressing force on the disc 100 can be changed.

As illustrated in FIG. 10, a second pressure-receiving surface 22 of the first pressure-receiving piston 2, which is a surface on the second pressure control section 202 side, and a second pressure-receiving surface 33 of the second pressure-receiving surface 3, which is a surface on the second pressure control section 302 side, may be arranged so as to be inclined with respect to the plane perpendicular to the axial direction. As a result, the amount of air flowing into the second pressure control section 202 and the second pressure control section 302 can be increased. In this manner, the speed of braking and releasing the disc 100 and the pressing force on the disc 100 can be changed.

### Seventh Embodiment

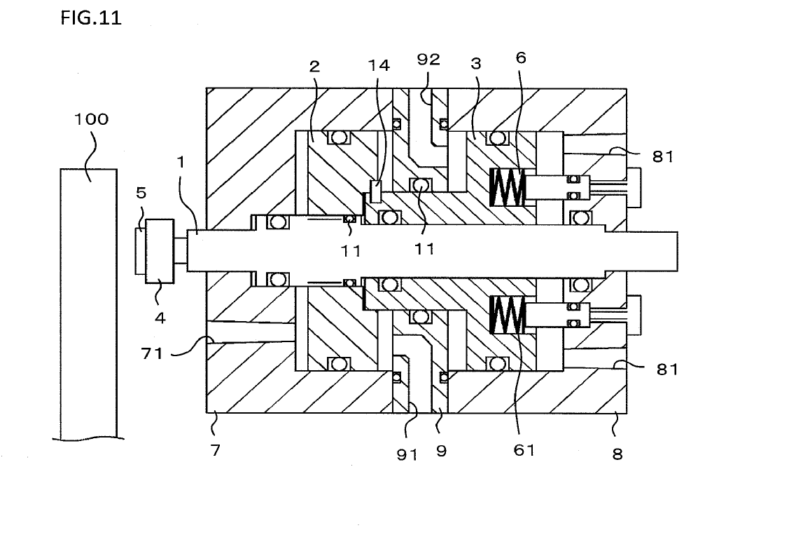

FIG. 11 is a sectional view for illustrating a brake device for an elevator hoisting machine according to a seventh embodiment of the present invention. In the first to sixth embodiments, the first pressure-receiving piston 2 and the second pressure-receiving piston 3 are arranged so as to be separated away from each other in the axial direction. On the other hand, in the brake device for an elevator hoisting machine according to the seventh embodiment, the first pressure-receiving piston 2 and the second pressure-receiving piston 3 are connected through the thread fastening. The brake device for an elevator hoisting machine further includes a rotation stopper member 14 configured to fix the first pressure-receiving piston 2 and the second pressure-receiving piston 3 to each other. A gap is formed between the rod 1 and the second pressure-receiving piston 3. The first pressure-receiving piston 2 is connected to the rod 1 through the thread fastening. The spring device 6 includes the plurality of springs 61. The plurality of springs 61 are arranged side by side in the circumferential direction of the rod 1. The number of the grooves 31, which corresponds to the number of the springs 61, are formed in the second pressure-receiving piston 3 so as to be arranged side by side in the circumferential direction. The springs 61 are respectively embedded in the grooves 31. The remaining configuration is the same as that of the first embodiment.

As described above, according to the brake device for an elevator hoisting machine of the seventh embodiment of the present invention, the first pressure-receiving piston 2 and the second pressure-receiving piston 3 move integrally with each other.

Therefore, the occurrence of twisting in the first pressure-receiving piston 2 and the second pressure-receiving piston 3 can be reduced.

In the seventh embodiment described above, the second pressure-receiving piston 3 is thread-fastened to the first pressure-receiving piston 2, and the second pressure-receiving piston 3 slides over the rod 1. However, the first pressure-receiving piston 2 may be thread-fastened to the second pressure-receiving piston 3, the gap may be formed between the rod 1 and the first pressure-receiving piston 2, and the first pressure-receiving piston 2 may slide over the rod 1.

### Eighth Embodiment

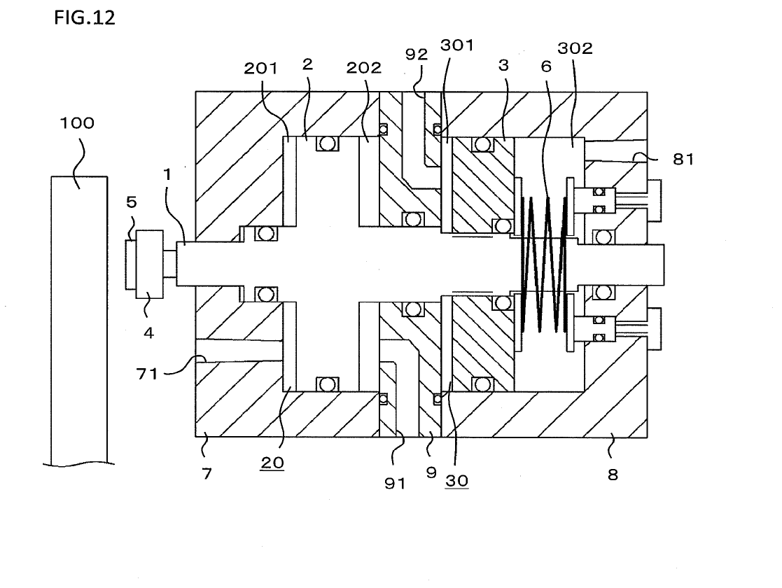

FIG. 12 is a sectional view for illustrating a brake device for an elevator hoisting machine according to an eighth embodiment of the present invention. In the fifth embodiment, the first pressure-receiving piston 2 is formed as a body independent of the rod 1. On the other hand, in the brake device for an elevator hoisting machine according to the eighth embodiment, the first pressure-receiving piston 2 is formed integrally with the rod 1. The remaining configuration is the same as that of the fifth embodiment.

As described above, according to the brake device for an elevator hoisting machine of the eighth embodiment of the present invention, the rotation stopper member 13 configured to fix the first pressure-receiving piston 2 to the rod 1 can be eliminated.

In the eighth embodiment described above, the first pressure-receiving piston 2 is formed integrally with the rod 1. However, the second pressure-receiving piston 3 may be formed integrally with the rod 1.

### Ninth Embodiment

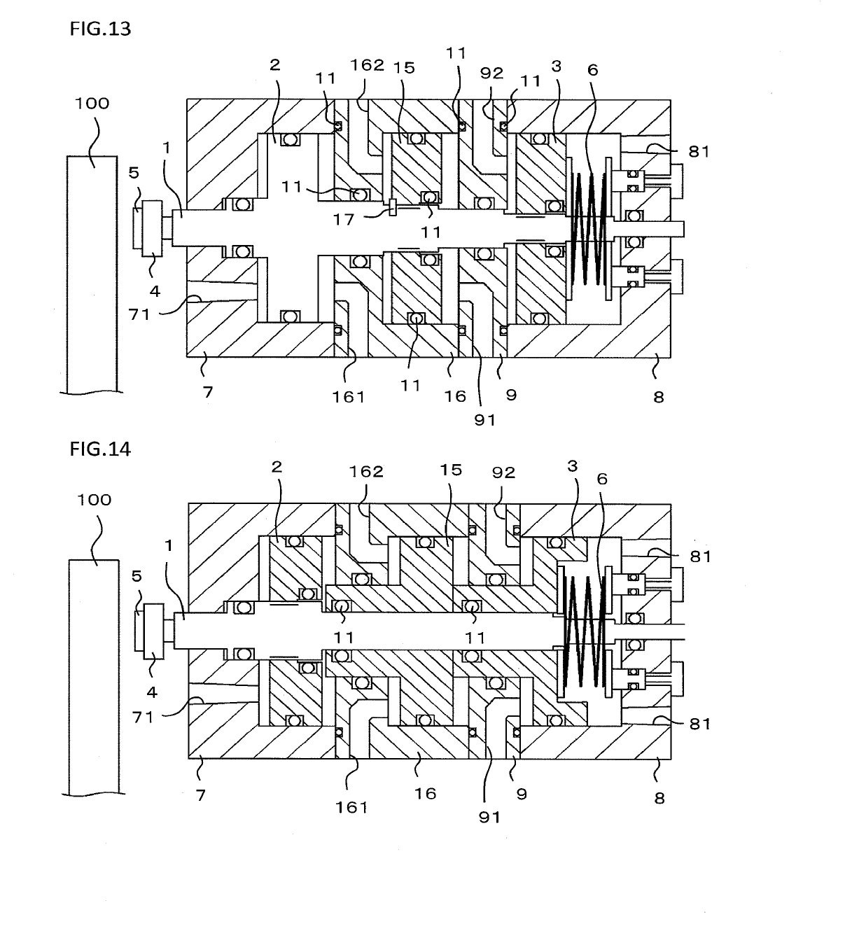

FIG. 13 is a sectional view for illustrating a brake device for an elevator hoisting machine according to a ninth embodiment of the present invention. In the first to eighth embodiments, the first pressure-receiving piston 2 and the second pressure-receiving piston 3 are provided. On the other hand, the brake device for an elevator hoisting machine according to the ninth embodiment further includes a third pressure-receiving piston 15, an intermediate cylinder tube 16 configured to guide the third pressure-receiving piston 15, and a rotation stopper member 17 provided between the third pressure-receiving piston 15 and the rod 1 in addition to the first pressure-receiving piston 2 and the second pressure-receiving piston 3. The first pressure-receiving piston 2 is formed integrally with the rod 1. After being thread-fastened to the rod 1, the third pressure-receiving piston 15 is fixed to the rod 1 by the rotation stopper member 17. A position of the second pressure-receiving piston 3 can be changed in the axial direction with respect to the rod 1. Through movement of the second pressure-receiving piston 3 with respect to the rod 1 in the axial direction, the distance between the lining 5 and the disc 100 is adjusted. The sealing members 11 are respectively provided between the intermediate cylinder tube 16 and the rod 1, between the first cylinder tube 7 and the intermediate cylinder tube 16, between the third pressure-receiving piston 15 and the intermediate cylinder tube 16, and between the third pressure-receiving piston 15 and the rod 1. The rotation stopper member 12 (FIG. 5) is not provided between the rod 1 and the second pressure-receiving piston 3. The remaining configuration is the same as that of the second embodiment.

As described above, according to the brake device for an elevator hoisting machine of the ninth embodiment of the present invention, the third pressure-receiving piston 15 is provided in addition to the first pressure-receiving piston 2 and the second pressure-receiving piston 3. Therefore, output can be increased while a radial dimension of the brake device for an elevator hoisting machine is maintained.

### Tenth Embodiment

FIG. 14 is a sectional view for illustrating a brake device for an elevator hoisting machine according to a tenth embodiment of the present invention. In the ninth embodiment, the first pressure-receiving piston 2 and the third pressure-receiving piston 15, which are pistons other than the second pressure-receiving piston 3 configured to adjust the distance between the lining 5 and the disc 100, are formed integrally with or thread-fastened to the rod 1. On the other hand, in the brake device for an elevator hoisting machine according to the tenth embodiment, for the second pressure-receiving piston 3 and the third pressure-receiving piston 15, which are pistons other than the first pressure-receiving piston 2 configured to adjust the distance between the lining 5 and the disc 100, the pressure is transmitted between the first pressure-receiving piston 2 and the second pressure-receiving piston 3 and between the second pressure-receiving piston 3 and the third pressure-receiving piston 15 through surface contact. Gaps are respectively formed between the second pressure-receiving piston 3 and the rod 1 and between the third pressure-receiving piston 15 and the rod 1. The sealing members 11 are respectively provided in the gaps. The remaining configuration is the same as that of the ninth embodiment.

As described above, according to the brake device for an elevator hoisting machine of the tenth embodiment of the present invention, the thread fastening between the third pressure-receiving piston 15 and the rod 1 is eliminated. Therefore, breakage of the thread-fastened portion can be prevented. In addition, the manufacture and assembly of the brake device for an elevator hoisting machine can be facilitated.

### Eleventh Embodiment

FIG. 15 is a sectional view for illustrating a brake device for an elevator hoisting machine according to an eleventh embodiment of the present invention. In the first to tenth embodiments, when the lining 5 comes into contact with the disc 100, the first pressure-receiving piston 2 and the first cylinder tube 7 come into contact with each other in the axial direction, while the second pressure-receiving piston 3 and the intermediate cylinder tube 9 come into contact with each other in the axial direction. On the other hand, the brake device for an elevator hoisting machine according to the eleventh embodiment further includes cushion rubbers (cushion members) 18 respectively provided between the first pressure-receiving piston 2 and the first cylinder tube 7 and between the second pressure-receiving piston 3 and the intermediate cylinder tube 9. The cushion rubbers 18 prevent the first pressure-receiving piston 2 and the first cylinder tube 7 from coming into contact with each other in the axial direction and prevent the second pressure-receiving piston 3 and the intermediate cylinder tube 9 from coming into contact with each other in the axial direction. The remaining configuration is the same as that of the third embodiment.

As described above, according to the brake device for an elevator hoisting machine of the eleventh embodiment of the present invention, the cushion rubbers 18 are respectively provided between the first pressure-receiving piston 2 and the first cylinder tube and between the second pressure-receiving piston 3 and the intermediate cylinder tube 9. Therefore, a shock generated when the first pressure-receiving piston 2 is pressed against the first cylinder tube 7 in the axial direction is absorbed, while a shock generated when the second pressure-receiving piston 3 is pressed against the intermediate cylinder tube 9 in the axial direction is absorbed. Further, noise generated when the first pressure-receiving piston 2 is pressed against the first cylinder tube 7 in the axial direction is reduced, while noise generated when the second pressure-receiving piston 3 is pressed against the intermediate cylinder tube 9 in the axial direction is reduced.

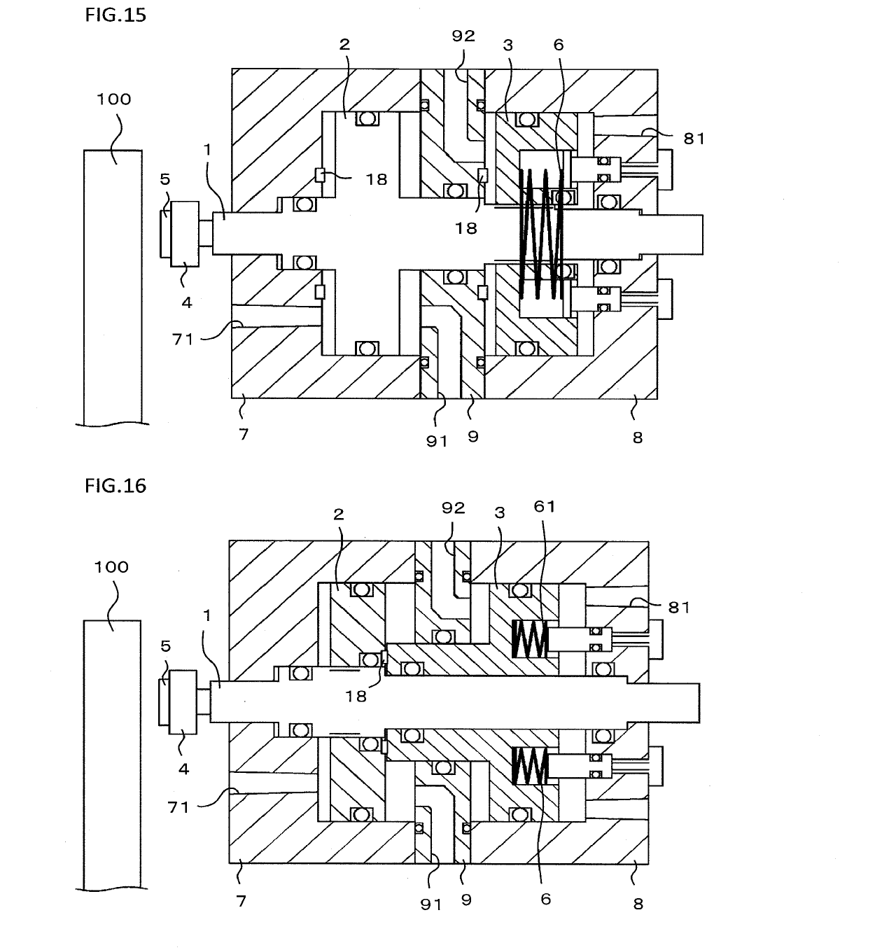

As illustrated in FIG. 16, the cushion rubber (cushion member) 18 may be provided between the first pressure-receiving piston 2 and the second pressure-receiving piston 3. In FIG. 16, the first pressure-receiving piston (fixed piston) 2 is fixed to the rod 1, whereas the second pressure-receiving piston (unfixed piston) 3 is arranged so as to form a gap with the rod 1.

### Twelfth Embodiment

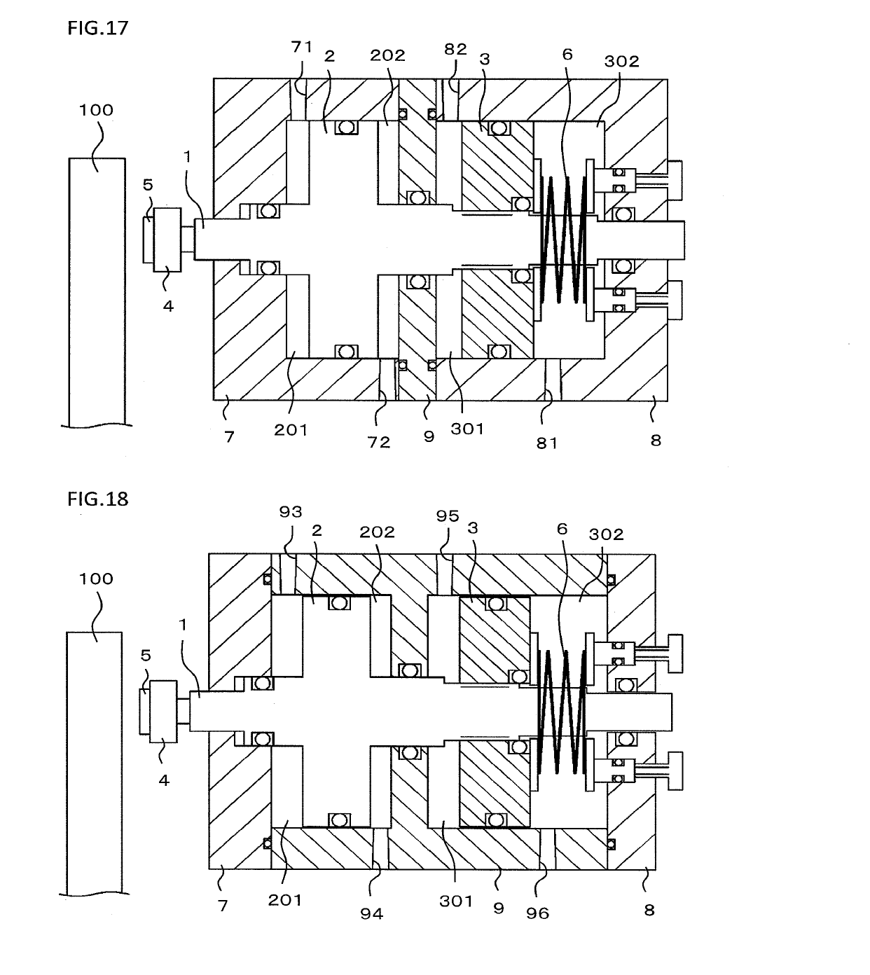

FIG. 17 is a sectional view for illustrating a brake device for an elevator hoisting machine according to a twelfth embodiment of the present invention. In the first to eleventh embodiments, the first air passage hole 71, the second air passage hole 81, the second air passage hole 91, and the first air passage hole 92 are arranged so as to be parallel to the axial direction of the rod 1. On the other hand, in the brake device for an elevator hoisting machine according to the twelfth embodiment, a second air passage hole 72 through which the air flows between the second pressure control section 202 and the outside is formed in the first cylinder tube 7, whereas a first air passage hole 82 through which the air flows between the first pressure control section 301 and the outside is formed in the second cylinder tube 8. The first air passage hole 71, the second air passage hole 72, the second air passage hole 81, and the first air passage hole 82 are arranged so as to be parallel to the plane perpendicular to the axial direction of the rod 1. The spring device 6 is arranged so as to be adjacent to the second pressure-receiving piston 3 in the axial direction. The remaining configuration is the same as that of the third embodiment.

As described above, according to the brake device for an elevator hoisting machine of the twelfth embodiment of the present invention, a position of a pipe connected to the brake device for an elevator hoisting machine can be changed. Thus, interference with the peripheral devices can be avoided.

In the twelfth embodiment described above, the first air passage hole 71, the second air passage hole 72, the second air passage hole 81, and the first air passage hole 82 are arranged so as to be parallel to the plane perpendicular to the axial direction of the rod 1. However, the first air passage hole 71, the second air passage hole 72, the second air passage hole 81, and the first air passage hole 82 may be arranged so as to be inclined with respect to the axial direction of the rod 1.

### Thirteenth Embodiment

FIG. 18 is a sectional view for illustrating a brake device for an elevator hoisting machine according to a thirteenth embodiment of the present invention. In the first to twelfth embodiments, the first pressure-receiving piston 2 slides inside the first cylinder tube 7, whereas the second pressure-receiving piston 3 slides inside the second cylinder tube 8. On the other hand, in the brake device for an elevator hoisting machine according to the thirteenth embodiment, the first pressure-receiving piston 2 slides inside the intermediate cylinder tube 9, and the second pressure-receiving piston 3 slides inside the intermediate cylinder tube 9. A first air passage hole 93 through which the air passes between the first pressure control section 201 and the outside, a second air passage hole 94 through which the air passes between the second pressure control section 202 and the outside, a first air passage hole 95 through which the air passes between the first pressure control section 301 and the outside, and a second air passage hole 96 through which the air passes between the second pressure control section 302 and the outside are formed in the intermediate cylinder tube 9. The remaining configuration is the same as that of the twelfth embodiment.

As described above, according to the brake device for an elevator hoisting machine of the thirteenth embodiment of the present invention, addition of structure configured to install the brake device for an elevator hoisting machine can be facilitated by changing a shape of the cylinder.

### Fourteenth Embodiment

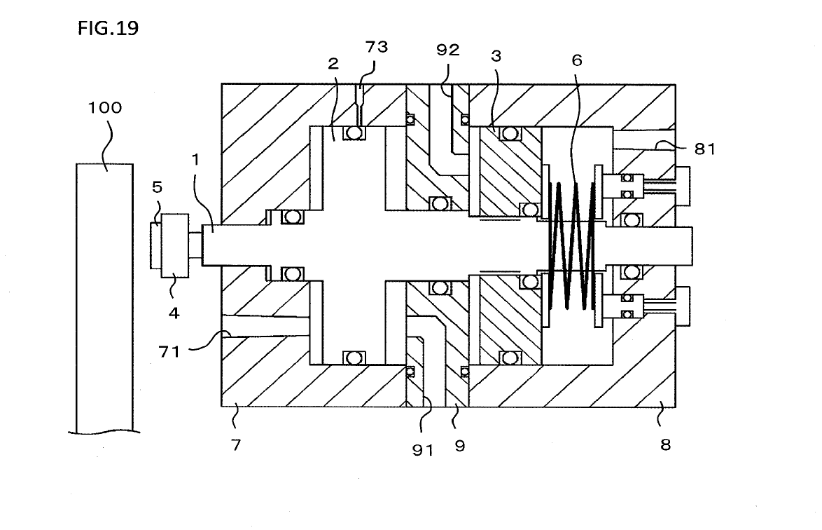

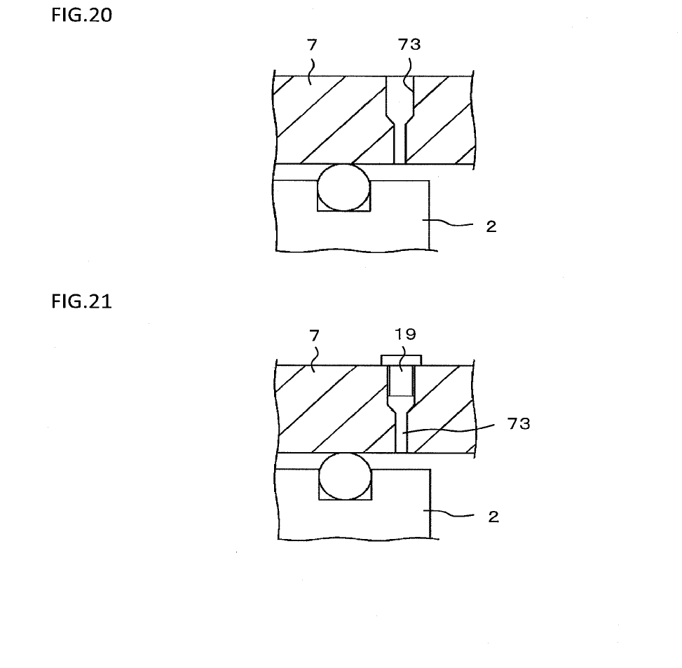

FIG. 19 is a sectional view for illustrating a brake device for an elevator hoisting machine according to a fourteenth embodiment of the present invention, and FIG. 20 is an enlarged view for illustrating a main part of the brake device for an elevator hoisting machine, which is illustrated in FIG. 19. In the first to thirteenth embodiments, when grease is applied to the first pressure-receiving piston 2 and the second pressure-receiving piston 3 or the grease is replaced for maintenance of a sliding portion of the brake device for an elevator hoisting machine, the brake device for an elevator hoisting machine is disassembled. On the other hand, in the brake device for an elevator hoisting machine according to the fourteenth embodiment, two or more grease replacement holes 73 are formed in the first cylinder tube 7 so as to be located on the same circumference. The spring device 6 is arranged so as to be adjacent to the second pressure-receiving piston 3 in the axial direction.

As a method of replacing the grease, there is given a method involving injecting new grease into one of the grease replacement holes 73 and extracting used grease from another of the grease replacement holes 73 without disassembling the brake device for an elevator hoisting machine. Further, as the method of replacing the grease, there is given a method involving injecting liquid capable of dissolving the grease, such as base oil for the grease, into one of the grease replacement holes 73, extracting the used grease from the another of the grease replacement holes 73, and then injecting the new grease into the grease replacement holes 73.

As illustrated in FIG. 21, the brake device for an elevator hoisting machine further includes grease replacement hole lids 19 configured to close the grease replacement holes 73. After the replacement of the grease, the grease replacement hole lids 19 are inserted into the grease replacement holes so as to maintain airtightness inside the cylinder. The remaining configuration is the same as that of the third embodiment.

As described above, according to the brake device for an elevator hoisting machine of the fourteenth embodiment of the present invention, the grease replacement holes 73 are formed in the first cylinder tube 7. Therefore, the grease can be replaced without disassembling the brake device for an elevator hoisting machine.

1. A brake device for an elevator hoisting machine, comprising:
a rod movable in an axial direction of the rod;
a plurality of pistons provided to the rod so as to be arranged side by side in the axial direction;
a cylinder configured to accommodate each of the plurality of pistons therein, the cylinder comprising a pressure control chamber formed between the cylinder and the each of the plurality of pistons;
a lining provided to the rod so as to be capable of coming into contact with a contacted body; and
a spring device configured to press the plurality of pistons in a direction in which the lining is pressed against the contacted body,
the brake device having gaps respectively formed between at least one of the plurality of pistons and the rod and between pistons adjacent to each other among the plurality of pistons,
the each of the plurality of pistons being configured to be driven by a change in air pressure in the pressure control chamber.

2. A brake device for an elevator hoisting machine according to claim 1, wherein:
the spring device comprises a plurality of springs; and
the plurality of springs are arranged side by side in a circumferential direction of the rod.

3. A brake device for an elevator hoisting machine according to claim 1, wherein the spring device is embedded in a groove formed in a corresponding one of the plurality of pistons.

4. A brake device for an elevator hoisting machine according to claim 1, wherein a speed of the rod is adjusted through control of a difference in air pressure between a first pressure control section corresponding to a region in the pressure control chamber, which is located closer to the lining than the each of the plurality of pistons, and a second pressure control section corresponding to a region in the pressure control chamber, which is located farther from the lining than the each of the plurality of pistons.

5. A brake device for an elevator hoisting machine according to claim 1, wherein:
the plurality of pistons comprise an unfixed piston arranged so as to form a gap with the rod and a fixed piston fixed to the rod; and
the unfixed piston and the fixed piston are connected to each other through intermediation of a cushion member when the lining comes into contact with the contacted body.

6. A brake device for an elevator hoisting machine, comprising:
a rod movable in an axial direction of the rod;
a plurality of pistons provided to the rod so as to be arranged side by side in the axial direction;
a cylinder configured to accommodate each of the plurality of pistons therein, the cylinder comprising a pressure control chamber formed between the cylinder and the each of the plurality of pistons;
a lining provided to the rod so as to be capable of coming into contact with a contacted body; and
a spring device configured to press the plurality of pistons in a direction in which the lining is pressed against the contacted body,
the each of the plurality of pistons being configured to be driven by receiving an air pressure in a first pressure control section corresponding to a region in the pressure control chamber, which is located closer to the lining than the each of the plurality of pistons, and an air pressure in a second pressure control section corresponding to a region in the pressure control chamber, which is located farther from the lining than the each of the plurality of pistons.

7. A brake device for an elevator hoisting machine according to claim 6, wherein:
the spring device comprises a plurality of springs; and
the plurality of springs are arranged side by side in a circumferential direction of the rod.

8. A brake device for an elevator hoisting machine according to claim 6, wherein the spring device is embedded in a groove formed in a corresponding one of the plurality of pistons.

9. A brake device for an elevator hoisting machine according to claim 6, wherein a speed of the rod is adjusted through control of a difference in air pressure between the first pressure control section and the second pressure control section.
